(19) United States
(12) Patent Application Publication
(10) Pub. No.: US 2025/0335442 A1
(43) Pub. Date: Oct. 30, 2025

(54) COMPILED CALL STUBS FOR EFFICIENT EXECUTION OF POLYGLOT QUERIES IN A DBMS

(71) Applicant: Oracle International Corporation, Redwood Shores, CA (US)

(72) Inventors: Altin Alickaj, Zurich (CH); Alexander Ulrich, Freiburg (DE); Laurent Phillipe Daynes, Saint-Ismier (FR)

(21) Appl. No.: 19/185,644

(22) Filed: Apr. 22, 2025

Related U.S. Application Data
(60) Provisional application No. 63/640,154, filed on Apr. 29, 2024.

(51) Int. Cl. G06F 16/2453; G06F 16/2452; G06F 16/2455

(52) U.S. Cl. CPC G06F 16/24547; G06F 16/24526; G06F 16/24552

(57) ABSTRACT

Here is query acceleration for a polyglot database by generation, reuse, partial evaluation, and compilation of a wrapper for invoking a user-defined stored subroutine that is defined by source logic text for an imperative language such as JavaScript. A database server receives a structured query language (SQL) statement that references a user-defined subroutine that is defined in the imperative language. Also defined in the imperative language, a wrapper subroutine is responsively generated. The wrapper subroutine specifies a datatype conversion for a parameter for the user-defined subroutine. Executing the SQL statement entails executing the wrapper subroutine, including executing the user-defined subroutine. Execution of the user-defined subroutine is unconventionally accelerated by logic generation that can be conditioned on database metrics, including just in time (JIT) compilation, and further accelerated by highly contextual partial evaluation.

### BENEFIT CLAIM

This application claims benefit under 35 U.S.C. § 119 (e) of provisional application 63/640,154, filed Apr. 29, 2024, by Altin Alicka et al, the entire contents of which is hereby incorporated by reference.

### FIELD OF THE DISCLOSURE

This disclosure relates to query acceleration for a polyglot database by generation, reuse, partial evaluation, and compilation of a wrapper for invoking a user-defined stored subroutine.

### BACKGROUND

Structured query language (SQL) is designed to efficiently interact with a relational database, minimizing the computational burden on the database server. SQL optimization is an important way to conserve computer resources such as processor time and memory space. An efficient query execution plan is optimized for factors such as indexes, data distribution, and available hardware resources to choose the fastest and least resource-intensive way to access requested data. SQL is designed to operate directly on bulk data within the database itself. This eliminates the need for transferring large amounts of data between the database and an application server, which can be a significant bottleneck in terms of network traffic and processing overhead.

By performing data manipulation and retrieval within the database engine, SQL minimizes data movement. SQL supports set-based operations, allowing users to perform complex data manipulations on entire sets of data with a single command. This approach may be more efficient than processing data row-by-row, as it allows the database engine to optimize operations at the set level, leading to significant performance gains and reduced resource consumption.

In the context of database management system (DBM S), embedded, server-side, in-process programming languages such as JavaScript facilitates execution of application logic that heavily interacts with a database directly. Because application logic is collocated with the database, network latency for database round trips is eliminated. In such a scenario, the interaction between different language runtimes may require coordination between a host subsystem such as SQL, with the embedded language such as JavaScript. Herein, host means native (i.e. built in) to the DBMS, and embedded means an extension to the DBMS, where the extension is within the DBMS's address space. Despite such multilingual (i.e. polyglot) integration, the different languages within the DBMS are not directly compatible and need adaption that operates slowly.

### BRIEF DESCRIPTION OF THE DRAWINGS

In the drawings:

FIG. 1 is a block diagram that depicts an example relational database management system (RDBMS) that accelerates execution of structured query language (SQL) statements that invoke user-defined subroutines;

FIG. 2 is a block diagram that depicts an example generated wrapper subroutine that has begun partial evaluation, including already inlining a user-defined subroutine into the wrapper subroutine;

FIG. 3 is a lifecycle diagram that depicts a finite state machine (FSM) that can be repeatedly instantiated;

FIG. 4 is a scenario diagram that depicts an unoptimized call that is a single invocation of an FSM that is in an unoptimized state;

FIG. 5 is a flow diagram that depicts an example query acceleration process performed by an RDBMS;

FIG. 6 is a block diagram that illustrates a computer system upon which an embodiment of the invention may be implemented;

FIG. 7 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

This disclosure relates to query acceleration for a polyglot database by generation, reuse, partial evaluation, and compilation of a wrapper for invoking a user-defined stored subroutine that is defined by source logic text for an imperative language. Unlike structured query language (SQL), the imperative language may be a scripting language that is Turing complete (i.e. general purpose). Herein, query execution entails execution of two source languages, which are SQL and the imperative language. These two languages have separate parsers, separate syntax, and separate semantics. Data exchanged between the two languages undergoes automatic datatype conversion so that a same data item can be processed in both languages.

Herein, a user-defined subroutine is a user-defined function (UDF) or a stored procedure. Herein, a polyglot query is a SQL statement that references a user-defined subroutine that is defined as source logic of a subroutine in the imperative language. Reuse of a logic skeleton as an instrumentation template is an innovative acceleration that dynamically generates partial evaluation contexts from queries. Unlike state of the art optimization of general purpose instrumentation, an additional innovative acceleration is that the approach herein is specialized for bulk data that is database data such as multifield records in multirow batches.

Another innovative acceleration, which is another bulk data specialization, are various innovative thresholds herein that dynamically detect when logic generation or logic compilation should, for query acceleration, no longer be deferred. These acceleration thresholds may be directly based on database metrics such as a count of table rows processed so far, a count of invocations of a user-defined subroutine so far, or a count of arguments in a user-defined subroutine.

### 1.0 Example Query Acceleration Computer Hosts Relational Database Management System (RDBMS)

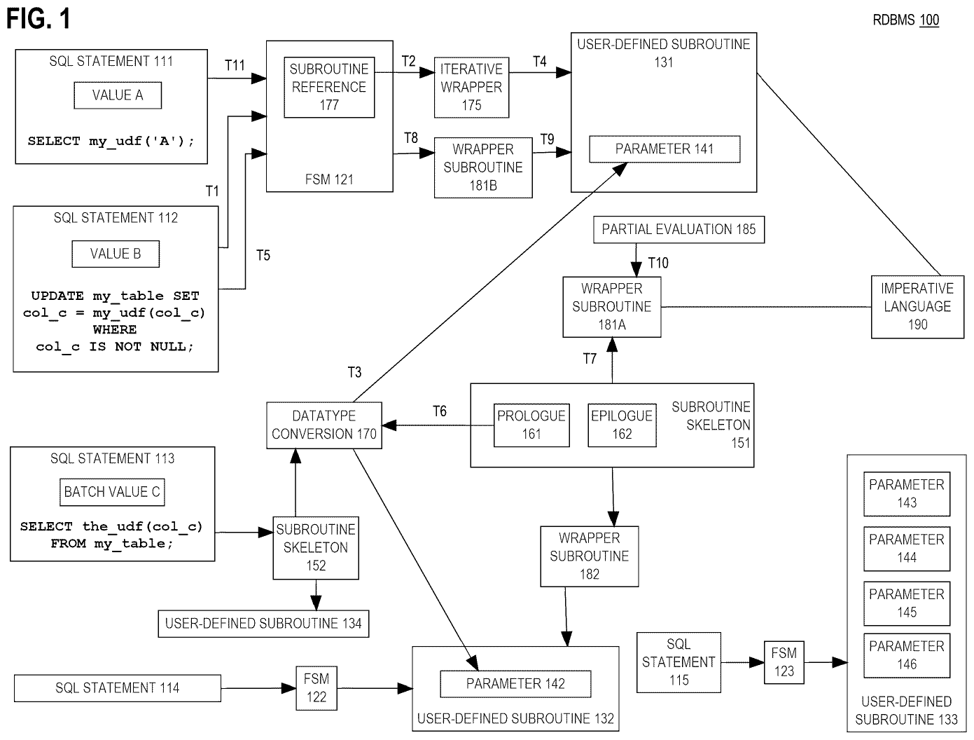

FIG. 1 is a block diagram that depicts example relational database management system (RDBMS) 100 that accelerates executed structured query language (SQL) statements 111-115 that invoke any of user-defined subroutines 131-134. RDBMS 100 is hosted by one or more computers such as a virtual machine, a blade or other rack server, or a mainframe.

Each of SQL statements 111-115 may consist of data query language (DQL) such as SQL statements 111 and 113 or may be data manipulation language (DML) such as SQL statement 112. A same SQL statement that is twice received by RDBMS 100 is processed herein as two separate SQL statements. The following is an example SQL statement 111 in which: a) my_udf is a UDF that is user-defined subroutine 131, b) user-defined subroutine 131 is invoked exactly once, and value A is the value of parameter 141 as discussed later herein.
SELECT my_udf(‘A’);

Execution of example SQL statement 111 invokes user-defined subroutine 131 exactly once. The following is a multisite example SQL statement that twice refers to my_udf (i.e. user-defined subroutine 131) and also refers to column col_c in my_table that is a relational table.

SELECT my_udf(‘A’) FROM my_table WHERE my_udf(‘B’) = col_c;

In the above multisite example SQL statement, my_udf(‘A’) is referred to herein as call site A, and my_udf(‘B’) is referred to herein as call site B. For example, call site B may be invoked more times than call site A. Each reference (i.e. call site) to same user-defined subroutine 131 in the above multisite example SQL statement shares instrumentation components 121 and 177 as discussed later herein.

Execution of the following example SQL statement 112 causes zero, one, or many invocations of user-defined subroutine 131.

UPDATE my_table SET col_c = my_udf(col_c) WHERE col_c IS
NOT NULL;

In example SQL statement 112, column col_c is in a relational table (not shown) that contains zero or more table rows. The WHERE clause may match none, some, or all of those rows, and user-defined subroutine 131 is invoked only for the subset of rows that satisfy the WHERE clause. Herein, matching rows are rows in my_table that would satisfy clause WHERE col_c IS NOT NULL. During one execution of the above example SQL statement 112, each invocation of user-defined subroutine 131 may, for example, use a respective distinct actual value as value B for parameter 141, and these invocations are accelerated as follows.

### 1.1 Poly Glot Database Instrumentation

For example at shown time T1, RDBMS 100 sequentially: 1) receives a first occurrence of SQL statement 112, 2) parses SQL statement 112, 3) detects that SQL statement 112 references a user-defined function (UDF) named my_udf (i.e. user-defined subroutine 131), and 4) generates finite state machine (FSM) 121 as instrumentation for binding user-defined subroutine 131 to SQL statement 112 in a way that facilitates executing both of components 112 and 131.

Although not shown, a second occurrence of same SQL statement 111 may be received, for which FSM 121 is reused. As discussed later herein, each distinct FSM has a respective distinct user-defined subroutine, and each distinct user-defined subroutine has exactly zero or one respective distinct FSM. There is no coordination nor dependency between two FSMs, even if both FSMs are for different user-defined subroutines invoked from a same SQL statement. As discussed later herein, one of subroutine skeletons 151-152 is the only generated artifact that may be shared between two FSMs.

SQL is a declarative language, not an imperative language. Imperative language 190 may, for example, be an interpreted scripting language such as JavaScript, Python, or Ruby. RDBMS 100 is a polyglot DBMS. Although not shown, RDBMS 100 may have multiple imperative languages and multiple database sessions. For example, multiple database sessions may use imperative language 190, and one database session may use multiple imperative languages.

Herein, a multilingual engine (MLE) can interpret one or multiple imperative language(s). For two database sessions to share imperative language 190, two respective separate instances of an MLE are used. One database session may have one MLE instance for multiple imperative languages. In the shown embodiment to increase database security: a) SQL statements 111-115 occur in a same database session of a same database client; b) in RDMS 100, two database sessions share none of the components shown in FIG. 1 except imperative language 190; and c) two database sessions do not share an instance of a multilingual engine (MLE).

RDBMS 100 supports user-defined subroutines that each may be a UDF or a stored procedure. User-defined subroutines 131-134 are not defined in a SQL dialect. Each of user-defined subroutines 131-134 is defined in an imperative language such as imperative language 190.

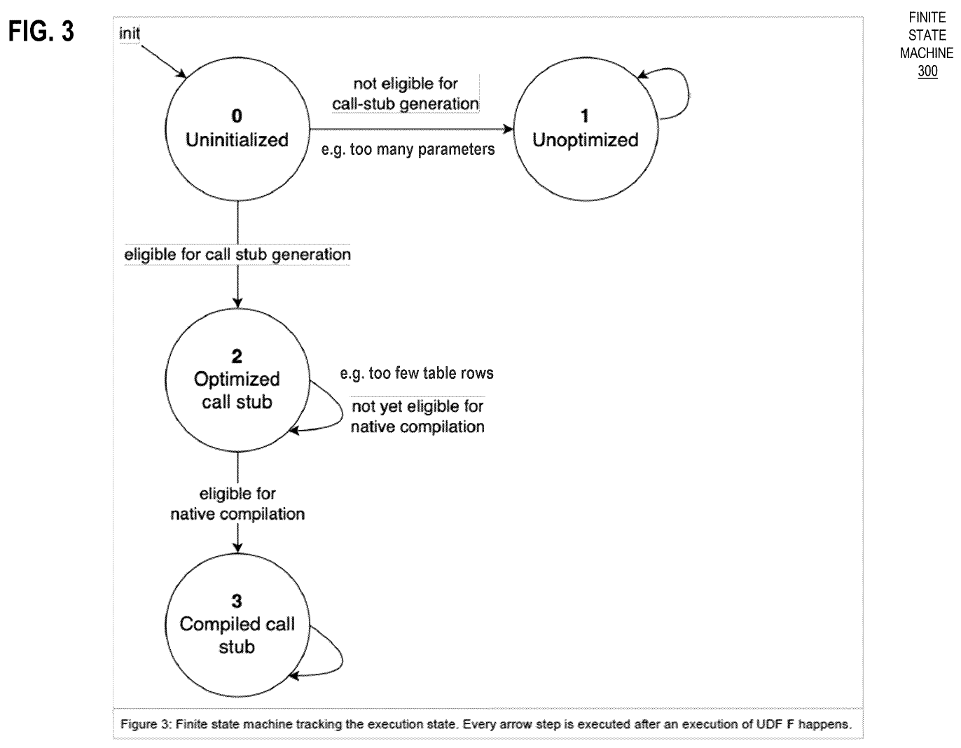

Each of FSMs 121 and 123 has a same potential lifecycle, referred to herein as the FSM lifecycle and shown in FIG. 3, even though each of SQL statements 111-112 and 115 are very different statements, and even though user-defined subroutines 131 and 133-134 are very different subroutines. As discussed later herein and as shown in FIG. 3, the FSM lifecycle irreversibly bifurcates between states 1-2 after initial state 0. As discussed later herein, FSM 121 reaches state 2 and never reaches state 1. Conversely, FSM 123 reaches state 1 and never reaches state 2. That is, SQL statement 115 is executed very differently than how SQL statements 111-112 are executed as follows.

In this example, shown times T1-T11 are sequential as numbered in FIG. 1. In other examples, times T1-11 may be somewhat reordered. For example, receipt or execution of SQL statements 111-115 may occur in a different ordering than the following discussed ordering.

An MLE does not support SQL datatypes, and MLE datatypes are not supported outside of the MLE. When SQL statement 112 executes, all input data to user-defined subroutine 131 should be converted from SQL datatypes to datatypes of imperative language 190. Conversely, when user-defined subroutine 131 finishes executing, all output data should be converted from datatypes of imperative language 190 to SQL datatypes.

Each of parameters 141-146 is a distinct formal parameter of one of user-defined subroutines 131-133. Each of parameters 141-146 has both of a respective SQL datatype and a respective datatype of imperative language 190. Two parameters of a same datatype may share a same conversion function that is defined in imperative language 190, such as datatype conversion 170. As shown, parameters 141-142 share datatype conversion 170 that may also be shared by zero or more of parameters 143-146.

The purpose of FSM 121 is to instrument and accelerate any datatype conversions of input(s) and output(s) of user-defined subroutine 131, including parameter 141. A user-defined subroutine has zero or more parameters. A UDF has exactly one return value, and a stored procedure has no return value. A parameter may be an input parameter, an output parameter, or both (i.e. an input/output parameter).

### 1.2 Iterative Data Type Conversion

FSM 121 contains subroutine reference 177 that may, for example, be implemented as a memory address of an imperative subroutine such as a function pointer. Herein, subroutine reference 177 never points to user-defined subroutine 131. Subroutine reference 177 can be reassigned exactly zero or one time during the lifecycle of FSM 121. As discussed earlier herein, one execution of SQL statement 112 may entail multiple invocations of user-defined subroutine 131, with a respective distinct table row providing value B at each invocation. In this embodiment, the first table row that satisfies (i.e. matches) the WHERE clause is processed during times T1-T4 and, for acceleration, all subsequent matching rows are instead processed in different ways during or after times T5-T9. In this embodiment, the first invocation of user-defined subroutine 131 (e.g. for a first matching table row) uses iterative wrapper 175 and, for acceleration, all subsequent invocations instead use wrapper subroutine 181B. At time T1, subroutine reference 177 is initialized to refer to newly instantiated iterative wrapper 175.

Iterative wrapper 175 is a generalized and universal wrapper that can be reused (i.e. instantiated) to wrap any user-defined subroutine, regardless of what is the signature of the subroutine, such as how many parameters and what are the datatypes of the parameters. For acceleration at time T1, generating iterative wrapper 175 is the fastest way to generate a new wrapper. For example, each of FSMs 121-123 may have a respective iterative wrapper instance as discussed later herein.

Times T1-T4 are synchronous, which means that they occur in immediate succession as a critical path of control flow during execution of SQL statement 112. This critical path occurs as foreground processing that is synchronous in a database session.

Each FSM contains a reference to exactly one MLE instance, and the MLE (not shown) contains a distinct respective conversion map (not shown) for each imperative language that the MLE supports. Herein, a conversion map contains multiple datatype conversion functions such as datatype conversion 170. Each FSM uses exactly one conversion map, and there is one conversion map per database session. If two FSMs are for (e.g. implemented in) a same imperative language 190, then both FSMs share a same conversion map.

Each datatype conversion function is directional. For example, a bidirectional (i.e. input/output) parameter should have two conversion functions, which is one function that accepts SQL data as input and another function that returns SQL data as output. Multiple parameters 141-142 have a same datatype and share the same one or two directional conversion function(s), including datatype conversion 170.

At time T2, FSM 121 dereferences subroutine reference 177 to invoke iterative wrapper 175. An iterative wrapper instance uses iteration to perform datatype conversion of all parameters of either of user-defined subroutines 131 and 133. For example as discussed later herein, another iterative wrapper instance (not shown) will perform datatype conversion for parameters 143-146 by converting exactly one distinct parameter in each distinct iteration in a sequence of four iterations.

Although not shown, each of wrappers 175, 181A-B, and 182 contains a subroutine reference that refers to a respective exactly one of user-defined subroutines 131-132. Different iterative wrapper instances may contain a subroutine reference to a respective any one of user-defined subroutines 131-134. As discussed above, all FSMs for a same imperative language 190 share a same single conversion map. At time T3 for FSM 121, an iteration by iterative wrapper 175: a) for parameter 141, retrieves input datatype conversion 170 from the conversion map and b) invokes datatype conversion 170 to convert value B (e.g. from a table row) for parameter 141.

After iterative conversion of all input parameters, iterative wrapper 175 invokes user-defined subroutine 131 at time T4. If user-defined subroutine 131 returns a value or has output parameter(s), then iterative wrapper 175 retrieves output datatype conversion(s) from the conversion map. In an embodiment, the conversion map consists of an input conversion map and an output conversion map.

### 1.3 Skeleton Logic Generated by Lifecycle Instrumentation

Herein, components 121, 123, 175, 181A-B, and 182 are in an MLE and operate without awareness of how many rows are in my_table, nor how many of those table rows have a null value in column col_c. Components 121, 123, 175, 181A-B, and 182 do not predict how many times will my_udf (i.e. user-defined subroutine 131) be invoked for a current execution of SQL statement 112. For example, a first execution of SQL statement 112 may invoke user-defined subroutine 131 fewer or more times than a second execution of same SQL statement 112. Each of FSMs 121 and 123 consists of multiple states and can transition from one state to another as shown in later FIG. 3.

Although each invocation of user-defined subroutine 131 for a same execution of SQL statement 112 causes a state transition in FSM 121 as discussed later herein, usually the transition is from a state to the same state as shown in FIG. 3, which is effectively the same as not transitioning. For a current execution of SQL statement 112, each state transition occurs immediately after a respective distinct invocation of user-defined subroutine 131. Most state transitions are not a transition to a different state, because usually the previous and next states of a transition are the same state as discussed later for FIG. 3. In the embodiment shown in FIG. 3, the first state transition (i.e. after the first invocation of user-defined subroutine 131 by the current execution of SQL statement 112) always transitions from the initial state to a different (i.e. non-initial) state. Other embodiments are discussed later herein.

As discussed earlier herein, execution of SQL statement 112 entails a critical path that occurs as foreground processing that is synchronous in a database session. When the approach herein is selectively applied according to thresholds later herein, logic generation occurs primarily or only for SQL statements likely to achieve acceleration, such as queries that process more than one table row. For example, suitable queries may have high latency as occurs in online analytic processing (OLAP) or reporting and, in that case, logic generation adds latency of a lesser order of magnitude than, for example, a multidimensional query would anyway incur. Due to this selectivity of logic generation for multirow queries, all logic generation herein may occur in the foreground of the database session.

For SQL statement 112, the first state transition in FSM 121 causes, in the foreground of the database session, dynamic generation of components 151, 161-162, and 181A-B. Wrapper subroutine 181A-B is actually only a same single component that is demonstratively redundantly shown in FIG. 1 because the lifecycle of the wrapper subroutine is biphasic with an initial ready phase, shown as wrapper subroutine 181A that, after more or less exhaustive refactoring by partial evaluation 185, is followed by an optimized phase shown as wrapper subroutine 181B.

In the shown example during a single execution of SQL statement 112: a) relational table my_table contains at least two table rows that do not contain a null in column col_c; and b) for the first two satisfactory (i.e. matching) rows, user-defined subroutine 131 is invoked a first and second time, shown as times T1 and T5.

The first matching row was processed during times T1-T4. Processing the second matching row occurs synchronously in the foreground of the database session during times T5-T9 as follows, including dynamic generation of components 151, 161-162, and 181A-B. Herein, each noniterative wrapper subroutine is an instantiation of a reusable logic template referred to herein as a subroutine skeleton. As follows, wrapper subroutine 181A-B is generated from reusable subroutine skeleton 151. At time T5, FSM 121 detects that subroutine skeleton 151 does not yet exist and generates subroutine skeleton 151. As discussed later herein, a subroutine skeleton contains all of the datatype conversions needed by one or more user-defined subroutines. Wrapper subroutine 181A-B is generated from subroutine skeleton 151 as follows.

### 1.4 Source Logic or Abstract Syntax Tree (AST)

As discussed later herein, imperative logic may be represented as textual source logic or as a parse tree such as an abstract syntax tree (AST). As discussed later herein, opensource Truffle is a logic framework that can: a) generate an AST by parsing source logic, b) generate an AST or subtree without source logic, c) execute a subroutine by interpreting the subroutine's AST, and d) compile an AST to hardware instructions for accelerated execution.

Herein, RDBMS 100 stores hand-coded source logic of user-defined subroutines. In some embodiments, either no source logic is automatically generated at all or no source logic is automatically generated for imperative language 190. In an embodiment, some or all automatically generated logic may be generated directly as an AST or subtree, such as with opensource Truffle. Subroutine skeleton 151 is reusable but should not (e.g. cannot) be executed because it functions solely as a logic template.

An embodiment may prefer opensource Truffle either for its ability to refactor an AST or for its high-performance native (i.e. backend) compiler that generates hardware instructions for an instruction set architecture (ISA) of a central processing unit (CPU). Respectively for JavaScript, Ruby, and Python, there are Graal.js, TruffleRuby, and GraalPython as opensource extensions to Truffle that are specialized for semantic analysis of a Truffle AST for their respective particular imperative language. Although Graal.js generates the fastest hardware logic, JavaScript examples discussed herein may instead be implemented with a different imperative language. Use herein of Graal.js, TruffleRuby, and GraalPython may entail automatic generation and parsing of source logic or, as discussed above, may instead entail direct generation of an AST or subtree without source logic.

### 1.5 Imperative Execution Modes

At time T6, FSM 121 uses the SQL datatype of parameter 141 as a lookup key to retrieve datatype conversion 170 from the conversion map. At time T6, FSM 121 generates prologue 161 that is logic that specifies an invocation of a respective conversion function for each input parameter of user-defined subroutine 131 as discussed later herein. For example, prologue 161 contains logic that invokes datatype conversion 170 for parameter 141. Datatype conversion 170 supports all parameters of a same datatype. As discussed later herein, datatype conversion 170 is reusable for multiple parameters 141-142, and subroutine skeleton 151 is reusable for multiple user-defined subroutines 131-132.

If a user-defined subroutine has multiple input parameters, then generated for that user-defined subroutine is a prologue that specifies multiple invocations of same or different respective conversion functions. For example, datatype conversion 170 may accept a SQL timestamp and, for a user-defined subroutine that has two timestamp input parameters, a prologue may be generated that invokes datatype conversion 170 twice.

Epilogue 162 converts datatypes in the reverse direction such as for output parameters and a return value of user-defined subroutine 131. Epilogue 162 is not generated if user-defined subroutine 131 is a stored procedure without output parameters. A prologue is not generated if a user-defined subroutine has no input parameters.

At time T7, FSM 121 generates wrapper subroutine 181A from subroutine skeleton 151. Although subroutine skeleton 151 can be reused for both of user-defined subroutines 131-132, components 121 and 181A-B are only generated and used to bind components 111-112 to 131. For maximum acceleration as discussed later herein, components 121 and 181A-B are dedicated to and specialized for components 131 and one or both of 111-112.

Herein, there are three execution modes for imperative logic components 131 and 170, and any one execution of logic component 131 or 170 entails exactly one of the execution modes. At earlier time T4, iterative wrapper 175 operated in the slowest execution mode that is a fully data-driven mode that generates FSM 121 but does not generate logic. Acceleration is provided by an interpreted mode at times T8-T9 that interprets logic that already was generated at times T6-T7. As discussed later herein, a hardware mode is the fastest because it executes generated logic that already was compiled into hardware instructions that are directly executed by the computer or virtual machine that hosts RDBMS 100.

### 1.6 Relational Database Integration and Logic Refactoring by Partial Evaluation

FSM 121 contains subroutine reference 177 that initially refers to iterative wrapper 175 until, at time T8, the execution mode is switched from fully data-driven mode to interpreted mode, and this switch entails adjusting FSM 121 by: a) reassigning subroutine reference 177 to refer to wrapper subroutine 181B and b) discarding iterative wrapper 175.

In some embodiments and scenarios, a current execution of SQL statement 112 entails a sequence of: 1) in fully data-driven mode, exactly one invocation of user-defined subroutine 131 respectively for exactly one matching row at earlier time T4 followed by 2) in interpreted mode for acceleration, multiple invocations of user-defined subroutine 131 respectively for multiple other matching rows at or after time T9.

At time T10 as discussed later for FIG. 3, wrapper subroutine 181B may undergo various logic transformations such as partial evaluation 185 and compilation to hardware instructions for execution in hardware mode instead of interpreted mode. While user-defined subroutine 131 is executing, eventually partial evaluation 185 and compilation to hardware instructions co-occur. Herein, partial evaluation is not an execution mode, even though Truffle partial evaluation occurs only during or immediately before execution. In a Truffle embodiment, compilation to machine instructions and partial evaluation 185 cooccur. In that case, partial evaluation 185 occurs only during compilation to machine instructions, but with just in time (JIT) compilation as discussed later herein, compilation and partial evaluations can recur for more acceleration, and Truffle provides JIT compilation. Partial evaluation 185 at time T10 can refactor based on parameters that are constant. For example, my_udf(‘A’) provides a constant input, but my_udf(col_c) does not, where col_c is a table column. Thus, partial evaluation 185 may depend on relational database semantics of SQL statement 112 and, as discussed elsewhere herein, may depend on how many rows has this execution of SQL statement 112 processed before partial evaluation such as with the following.

In a Truffle embodiment, the Truffle dynamic profiler instruments and observes (e.g. repeated) execution of wrapper subroutine 131B to dynamically decide when to JIT compile part or all of either or both of subroutines 131 and 181B. A dynamic profiler may observe distinct or duplicate actual values for value B and parameter 141. Partial evaluation may be based on one or multiple actual values for value B and parameter 141 in the following ways. For example, a Truffle embodiment may perform partial evaluation, including logic specialization for value(s) seen so far, and including a deoptimization point to undo the specialization if later a new value occurs that the specialization cannot handle. The more values (e.g. from table rows) observed before partial evaluation, the more likely it is that the generated deoptimization point will not actually be used. Thus, there is a design tension between: a) increasing confidence (i.e. unlikelihood of causing deoptimization) in logic specialization by delaying or repeating partial evaluation to obtain more observed values, versus b) avoiding interpreted mode by performing compilation and partial evaluation as soon as possible. Various counting thresholds that control the timing of optimizations are discussed elsewhere herein.

Partial evaluation 185 may entail any of the following refactorings: a) an inlining of one subroutine into another, b) a dead code elimination of a logic statement or of a lexical block of logic, c) a constant folding, and d) a partial evaluation based on type polymorphism of parameter 141 that may, for example, reveal that a numeric constant is an integer instead of a real.

After generation of wrapper subroutine 181A at time T7 as discussed above, partial evaluation 185 occurs without invoking user-defined subroutine 131. Herein, partial evaluation is not an execution mode, even though Truffle partial evaluation occurs only during or immediately before execution. Partial evaluation 185 at time T10 can refactor based on parameters that are constant. For example, my_udf(‘A’) provides a constant input, but my_udf(col_c) does not, where col_c is a table column. Thus, partial evaluation 185 depends on relational database semantics of SQL statement 112.

Partial evaluation 185 may entail any of the following refactorings: a) an inlining of one subroutine into another, b) a dead code elimination of a logic statement or of a lexical block of logic, c) a constant folding, and d) a partial evaluation based on type polymorphism of parameter 141 that may, for example, reveal that a numeric constant is an integer instead of a real.

After generation of wrapper subroutine 181A at time T7 as discussed above, partial evaluation 185 occurs without invoking user-defined subroutine 131. Herein, partial evaluation is not an execution mode, even though Truffle partial evaluation occurs only during or immediately before execution. Partial evaluation 185 at time T10 can refactor based on parameters that are constant. For example, my_udf(‘A’) provides a constant input, but my_udf(col_c) does not, where col_c is a table column. Thus, partial evaluation 185 depends on relational database semantics of SQL statement 112.

Partial evaluation 185 may entail any of the following refactorings: a) an inlining of one subroutine into another, b) a dead code elimination of a logic statement or of a lexical block of logic, c) a constant folding, and d) a partial evaluation based on type polymorphism of parameter 141 that may, for example, reveal that a numeric constant is an integer instead of a real.

After generation of wrapper subroutine 181A at time T7 as discussed above, partial evaluation 185 occurs without invoking user-defined subroutine 131. Herein, partial evaluation is not an execution mode, even though Truffle partial evaluation occurs only during or immediately before execution. Partial evaluation 185 at time T10 can refactor based on parameters that are constant. For example, my_udf(‘A’) provides a constant input, but my_udf(col_c) does not, where col_c is a table column. Thus, partial evaluation 185 depends on relational database semantics of SQL statement 112.

Partial evaluation 185 may entail any of the following refactorings: a) an inlining of one subroutine into another, b) a dead code elimination of a logic statement or of a lexical block of logic, c) a constant folding, and d) a partial evaluation based on type polymorphism of parameter 141 that may, for example, reveal that a numeric constant is an integer instead of a real.

The interpreted mode, wrapper subroutine 181B sequentially invokes: 1) datatype conversion 170 to generate, from the value of column col_c of the current table row, an actual argument value for parameter 141 and 2) user-defined subroutine 131. Hardware mode for maximum acceleration is discussed later herein.

In one example, the execution of SQL statement 112 matches more than two table rows and invokes user-defined subroutine 131 more than twice. In that case, each of the first, second, and third matching rows is processed in a respective distinct way as follows. The first row is processed by iterative wrapper 175 at time T2 without generating logic. The second row is instead processed by generating and, at time T8, invoking wrapper subroutine 181B. Unlike for the second row, processing the third row does not entail logic generation because wrapper subroutine 181B is instead reused.

SQL statement 111 is processed at time T11 that does not entail logic generation because wrapper subroutine 181B is again reused. More or less immediately after time T11, execution of components 111, 131, and 181B finishes successfully and, for example, returns the result of user-defined subroutine 131 to a database client.

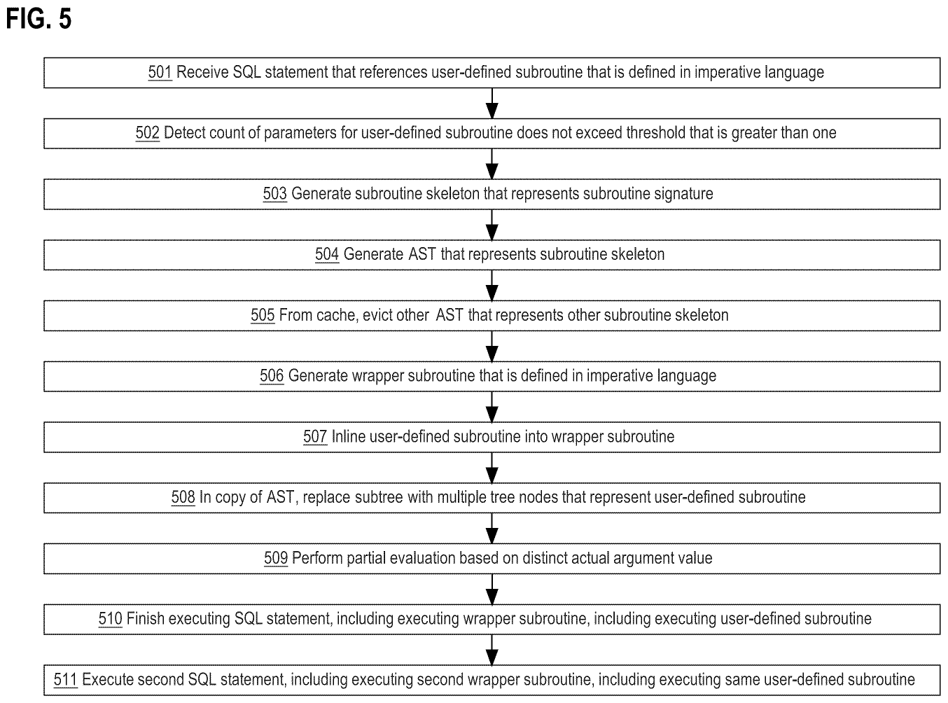

Herein, a subroutine signature specifies how many parameters and what are the datatypes of the parameters of a user-defined subroutine. SQL statement 114 references user-defined subroutine 132. Because user-defined subroutines 131-132 have the same subroutine signature (i.e. count, order, and type of parameters and, if any, a return type), subroutine skeleton 151 is reused to generate wrapper subroutine 182 as discussed later herein for FIG. 5. Components 115, 123, 133, and 143-146 are discussed later herein for FIG. 3.

### 1.7 Conversion Batching

Example SQL statement 112 specifies multiple uses of column col_c, including reading, writing, filtering, and passing to parameter 141 as actual argument value B. Unlike value A that literally occurs in SQL statement 111, value B is dynamically read as the value from column col_c, respectively for each matching row. RDMS 100 contains a query execution engine (not shown) that executes SQL statements 111-115 and delegates invocations of user-defined subroutines 131-134 to the MLE of imperative language 190. One execution of SQL statement 112 may find millions of matching rows and invoke user-defined subroutine 131 millions of times. At each of multiple invocations of wrapper subroutine 181B, exactly one respective distinct matching row is processed in a way that entails cooperation of the query execution engine and the MLE. Execution of SQL statement 112 repeats most or all of the cooperation overhead (i.e. computational latency) for each matching row. Acceleration by avoidance of that overhead is as follows. In the following example SQL statement 113, the_udf is a UDF that is user-defined subroutine 134.
SELECT the_udf(col_c) FROM my_table;

Execution of SQL statement 113 is accelerated by batching of data that is converted and/or transferred into and out of user-defined subroutine 134. For acceleration, repeated cooperation overhead is avoided by performing cooperation once per batch, such as cooperating once for the query execution engine to provide a batch of input row values from column col_c, and cooperating once again to return output results from the MLE for those rows. For example, batch value C may be an array of values, and execution of SQL statement 113 may entail processing multiple batches.

2.0 Example Distributed System with Multiple Example Storage Computers

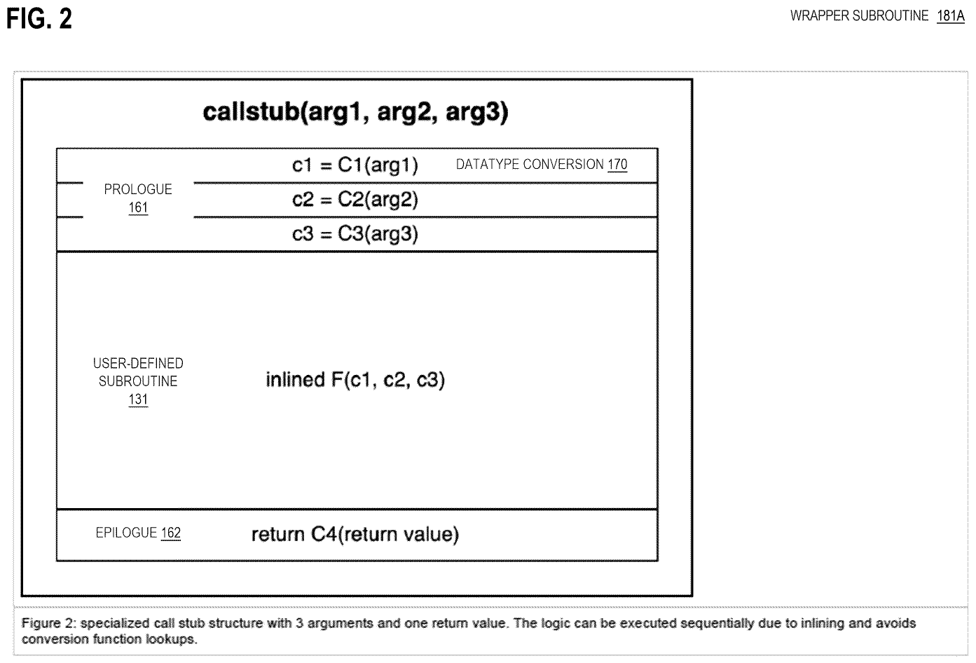

FIG. 2 is a block diagram that depicts example generated wrapper subroutine 181A that has begun partial evaluation 185, including already inlining user-defined subroutine 131 into wrapper subroutine 181A. Functions C1-C4 are datatype conversion functions that were already retrieved from the conversion map discussed earlier herein. Partial evaluation 185 may inline any of functions C1-C4. As shown, prologue 161 specifies invocations of functions C1-C3. Function C1 is datatype conversion 170. For acceleration, execution of wrapper subroutine 181B at time T8 does not access the conversion map. W rapper subroutine 181A may be a Truffle AST that is being refactored by partial evaluation 185. In various embodiments, one, some, or all of components 161-162 and 181A-B do not specify iteration nor conditional logic. This provides acceleration by avoiding a processor hardware pipeline stall such as due to a branch misprediction.

### 3.0 Example Instrumentation Lifecycle

FIG. 3 is a lifecycle diagram that depicts finite state machine (FSM) 300 from which all of FSMs 121 and 123 are instantiated. That is, FSM 300 may be either of FSMs 121 or 123. FSM 300 initially is in initial state 0, such as at time T1 in FIG. 1. In FIG. 3, user-defined function (UDF) F is any of user-defined subroutines 131-134.

Latency of generating prologue 161 in FIG. 2 scales according to the sum of: a) the count of input parameters and b) the count of output parameters and return value, where input/output parameters are counted twice. Semantic analysis by partial evaluation 185 for refactoring user-defined subroutine 131 may entail some nonlinear (i.e. worse than linear) latency that is a cost that can be amortized over all subsequent invocations of user-defined subroutine 131.

FSM 123 in FIG. 1 transitions to unoptimized state 1 in FIG. 3 because user-defined subroutine 133 has a count of parameters 143-146 that exceeds a logic generation threshold. Thus, FSM 123 always uses an iterative wrapper as discussed earlier herein, and this accelerates execution of SQL statement 115 by avoiding logic generation. Fully data-driven mode is used when FSM 123 is in unoptimized state 1. FSM 123 processes all involved table rows, if any, while in unoptimized state 1. As discussed earlier herein, each matching table row may cause an invocation of a user-defined subroutine, and a state transition in an instance of FSM 300 occurs after each invocation. States 0-1 of a same instance of FSM 300 use a same instance of an iterative wrapper to process some row(s). In that way, states 0-1 are functionally identical such that state 0 for FSM 123 may process a first row, and state 1 may process all subsequent rows if any. Likewise as follow with FSM 121, state 0 may process a first row, and state 2 may process some or all subsequent matching rows if any.

FSM 121 is separately invoked at respective times T1, T5, and T11. In the embodiment shown in FIG. 3 at time T1 in FIG. 1, FSM 121 transitions to optimized state 2 in FIG. 3 because user-defined subroutine 131 does not have too many parameters. In an embodiment of FSM 300 not shown, initial state 0 may transition back to initial state 0 and remain in state 0 for multiple invocations of user-defined subroutine 131, such as until a threshold count of multiple invocations. When FSM 121 transitions from state 0 to optimized state 2, subroutine skeleton 151 is generated at time T6.

When FSM 121 transitions from state 0 to optimized state 2, wrapper subroutine 181A is generated at time T7 and partial evaluation 185 occurs at time T10. Interpreted mode is used when FSM 121 is in optimized state 2. FSM 121 remains in optimized state 2 for a few table rows being processed first. No matter how many rows are processed by repeated invocations of FSM 121 in optimized state 2, times T6-T7 only occur once and are not repeated by FSM 121.

FSM 121 transitions from state 2 to compiled state 3 when FSM 121 is invoked a count of times that exceeds a logic compilation threshold. When FSM 121 transitions from state 2 to compiled state 3, wrapper subroutine 181B is compiled into hardware processor instructions by a backend of a compiler of imperative language 190. Operation of the compiler backend is just-in-time (JIT) while SQL statement 112 executes. For example if the compilation threshold is fifty invocations (e.g. of wrapper subroutine 181B), then the first, second, and third table rows are processed in three distinct ways as discussed earlier herein, which in FIG. 3 are: 1) the first row is processed by iterative wrapper 175 at time T4 while FSM 121 is in state 0; 2) the second row is processed by generating wrapper subroutine 181B; and 3) the third row is processed by reusing wrapper subroutine 181B. Eventually a fiftieth row at the compilation threshold is processed by compiling wrapper subroutine 181B to machine instructions when FSM 121 transitions from state 2 to state 3, and all rows after that are accelerated processed by reusing those machine instructions while FSM 121 remains in state 3.

Compiled state 3 uses the hardware mode as discussed earlier herein to process table rows faster than optimized state 2 processes table rows. Despite being functionally equivalent to the state of the art, unoptimized state 1 is the slowest way to process table rows.

### 4.0 Example Iterative Wrapper

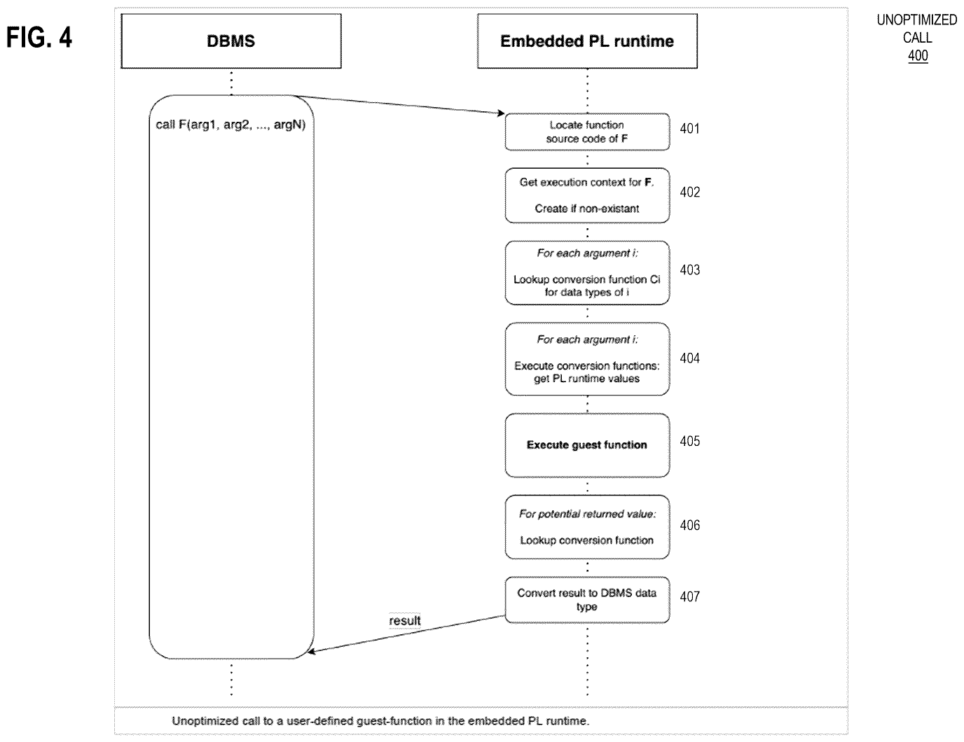

FIG. 4 is a scenario diagram that depicts unoptimized call 400 that, during execution of SQL statement 115, entails a single invocation of FSM 123 in FIG. 1 in unoptimized state 1 in FIG. 3. However as discussed below, when the process of FIG. 4 begins, FSM 123 may or may not yet exist. The DBMS shown in FIG. 4 is RDBMS 100. The embedded programing language (PL) runtime shown in FIG. 4 is a multilingual engine (MLE) instance for imperative language 190. In FIG. 4, user-defined function (UDF) F is any of user-defined subroutines 131-133.

FIG. 4 also contains a flow diagram that depicts a process having steps 401-407 that the MLE instance performs that can, if not already available for reuse when step 401 begins, generate FSM 123 in initial state 0 and transition and use FSM 123 in unoptimized state 1. If FSM 123 already exists, FSM 123 already is in state 1, and step 401 is skipped. As discussed earlier herein, RDBMS 100 retains source logic text of user-defined subroutine 133, which step 401 selects. Referred to herein as an execution context, FSM 123 is generated by step 402 if not yet existent, which is the case only for the first invocation of user-defined subroutine 133. Generation of FSM 123 entails instantiating an iterative wrapper and retaining a reference to the iterative wrapper in FSM 123 and, in the iterative wrapper, retaining a reference or copy of the source logic text of user-defined subroutine 133.

That wrapper is iterative because in the MLE the wrapper performs iterative steps 403-404 to iteratively process four input parameters 143-146 in four iterations. Each iteration of steps 403-404 processes a distinct one of input parameters 143-146. In each iteration, step 403 retrieves a respective datatype conversion from the conversion map as discussed earlier herein. In each iteration, step 404 invokes the respective datatype conversion of a distinct input parameter to convert a respective actual argument value from a structured query language (SQL) datatype to an MLE datatype.

At step 405, FSM 123 dereferences its subroutine reference and invokes user-defined subroutine 133. Steps 406-407 correspond to steps 403-404, except that steps 406-407 process outputs (i.e. return value and output parameters) instead of inputs, which means that datatype conversion is from MLE datatypes to SQL datatypes. The result value from step 407 is returned to the query execution engine in RDBMS 100 for further processing according to a query plan that represents SQL statement 115. If this execution of SQL statement 115 invokes user-defined subroutine 133 for multiple table rows, then the sequence of steps 403-407 may be repeated for each table row.

### 5.0 Example Query Acceleration Process

FIG. 5 is a flow diagram that depicts an example query acceleration process performed by RDBMS 100. In this example, steps 501-510 accelerate SQL statement 112 and, due to retention and reuse of subroutine skeleton 151, step 511 readily accelerates SQL statement 114. Distinct SQL statements 112 and 114 reference respective distinct user-defined subroutines 131-132. Subroutine skeleton 151 does not reference any of user-defined subroutines 131-133. In one example, user-defined subroutine 131 preexists subroutine skeleton 151, and subroutine skeleton 151 preexists user-defined subroutine 132.

Step 501 receives SQL statement 112 that references user-defined subroutine 131. In an embodiment, some or all SQL statements are received in a same database session or in respective distinct database sessions. In an embodiment, a SQL statement is autonomously generated by RDBMS 100 for step 501 with or without a database session. In an embodiment, step 501 uses open database connectivity (ODBC) with a network connection to a database client.

Between steps 501-502, RDBMS 100 parses, plans, and relationally optimizes SQL statement 112. Parsing or planning may entail generation of a query tree that represents SQL statement 112.

Between steps 501-502, RDMS 100 operates as follows. In the query tree, a reference (i.e. call site) that specifies an invocation of user-defined subroutine 131 is detected. Between steps 501-502: a) FSM 121 is generated in the MLE instance; b) by inspection of the call site in SQL statement 112 or by inspection of user-defined subroutine 131, the subroutine signature of user-defined subroutine 131 is discovered, including a count of how many parameters does the subroutine signature have; and c) FSM 121 instantiates an iterative wrapper and uses the wrapper for a first invocation of user-defined subroutine 131. After invoking the iterative wrapper, while FSM 121 transitions from state 0 to state 2 in FIG. 3 as follows, FSM 121 performs steps 502-509 in the foreground of the database session.

Step 502 detects that the count of parameters does not exceed a predefined maximum parameters threshold that is greater than one. For example if the parameter count threshold is three, then user-defined subroutine 131 does not exceed the threshold (but user-defined subroutine 133 would).

Discussed later herein is a skeleton cache in random access memory (RAM) of RDBMS 100. After detecting that the skeleton cache does not contain subroutine skeleton 151 because subroutine skeleton 151 does not yet exist, step 503 generates subroutine skeleton 151 to represent the subroutine signature of user-defined subroutine 131.

Steps 503-504 are a same single step or separate steps depending on the embodiment. In an embodiment, step 503 generates subroutine skeleton 151 as source logic text that step 504 parses to generate a skeleton abstract syntax tree (AST) that represents subroutine skeleton 151. Herein, a skeleton AST is a whole AST of a whole compilation unit, which does not mean that a skeleton AST can or should be executed. In an embodiment, the skeleton AST is directly generated without generating source logic, in which case steps 503-504 are a same single step. Opensource Truffle supports both ways.

As discussed above, some embodiments of step 503 generate subroutine skeleton 151 as source logic text. In various embodiments of step 503, the generated source logic of subroutine skeleton 151 is expressed in either imperative language 190 or a domain specific language (DSL) such as an interface description language whose grammar is much simpler than imperative language 190. That is, subroutine skeleton 151 may be generated by step 503 as DSL that step 504 parses to generate the skeleton AST.

Step 505 stores the skeleton AST in the skeleton cache. If the cache already was full (i.e. filled to capacity), step 505 makes room for the skeleton AST by evicting (i.e. discarding), from the cache, an AST that represents another subroutine skeleton.

Step 506 generates wrapper subroutine 181A as discussed earlier herein. Steps 507-509 perform refactoring by applying partial evaluation 185 as follows. Step 507 inlines user-defined subroutine 131 into wrapper subroutine 181A as shown in FIG. 2.

Step 508 is a sub-step or implementation of step 507. In an embodiment, steps 507-508 are a same single step. That is, step 507 performs inlining, and step 508 performs replacing, and both of these may be a same single activity. Step 508 makes a copy of the skeleton AST. In the copy of the AST, step 508 replaces a) a subtree that contains a tree leaf with b) a new subtree that consists of multiple tree nodes that represent the body of user-defined subroutine 131.

For ease of demonstration only, step 509 is discussed for SQL statement 111 instead of SQL statement 112. If user-defined subroutine 131 had a second parameter (not shown) whose value were a literal constant in SQL statement 112, then SQL statement 112 would be sufficient to exercise step 509. Step 509 is only part of partial evaluation 185. Even when optional step 509 is skipped or unimplemented, partial evaluation 185 is still exhaustively applied for other refactoring. Step 509 performs further partial evaluation that is based on distinct actual argument value A in SQL statement 111. For example, step 509 may perform dead code elimination on a logic statement in user-defined subroutine 131 that is reachable only when parameter 141 is not value A.

Steps 502-509 occurs when FSM 121 transitions from state 0 to state 2 in FIG. 3. Although FSM 121 is in state 2 when step 510 begins, step 510 may or may not eventually transition FSM 121 to state 3. That is, step 510 may end while FSM 121 is in either of states 2-3.

Although steps 509-510 are presented as distinct sequential steps, partial evaluation 185 by step 509 may or may not be exhaustive. For example with Truffle, step 510 may entail further partial evaluation at any time while any of the following is ongoing: a) while FSM 121 is in state 2 or transitioning to state 3 or b) with just in time (JIT) compilation to machine instructions, while FSM already is in state 3. Step 510 includes finishing executing SQL statement 112, including executing wrapper subroutine 181B while FSM 121 is in state 2 or 3, including accelerated executing user-defined subroutine 131 as already inlined and refactored.

Step 511 does not use FSM 121 and instead generates FSM 122 as follows. Step 511 receives SQL statement 114 and, because user-defined subroutines 131-132 have a same subroutine signature, subroutine skeleton 151 is reused in the skeleton cache to accelerate generation of wrapper subroutine 182 by step 511 as discussed earlier herein. Step 511 executes SQL statement 114, including executing wrapper subroutine 182, including executing user-defined subroutine 132 with any acceleration(s) presented herein. Although wrapper subroutines 181A and 182 both use datatype conversion 170 for respective parameters 141-142, wrapper subroutines 181A and 182 may use respective distinct implementations of datatype conversion 170. A respective partial evaluation of each of wrapper subroutines 181A and 182 may generate a respective distinct implementation of datatype conversion 170. Both of these distinct implementations of datatype conversion 170 need not be logically equivalent. For example, code that is eliminated as dead code in datatype conversion 170 for wrapper subroutine 182 might not be dead code in datatype conversion 170 for wrapper subroutine 181A. That is, those two distinct implementations of datatype conversion 170 might not be logically equivalent, and both of these distinct implementations of datatype conversion 170 may achieve near-optimal acceleration for their respective SQL statements. This near-optimal acceleration by these two implementations of datatype conversion 170 is greater than could be achieved by any one logic implementation (i.e. state of the art) that could handle both SQL statements 112 and 114. Likewise, those two distinct implementations of datatype conversion 170 might, for example, respectively be compiled (i.e. FSM 300 state 3) and uncompiled (i.e. state 2).

### 6.0 Database System Overview

A database management system (DBMS) manages one or more databases. A DBMS may comprise one or more database servers. A database comprises database data and a database dictionary that are stored on a persistent memory mechanism, such as a set of hard disks. Database data may be stored in one or more data containers. Each container contains records. The data within each record is organized into one or more fields. In relational DBM Ss, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology.

Users interact with a database server of a DBM S by submitting to the database server commands that cause the database server to perform operations on data stored in a database. A user may be one or more applications running on a client computer that interact with a database server. Multiple users may also be referred to herein collectively as a user.

A database command may be in the form of a database statement that conforms to a database language. A database language for expressing the database commands is the Structured Query Language (SQL). There are many different versions of SQL, some versions are standard and some proprietary, and there are a variety of extensions. Data definition language (“DDL”) commands are issued to a database server to create or configure database objects, such as tables, views, or complex data types. SQL/XML is a common extension of SQL used when manipulating XML data in an object-relational database.

A multi-node database management system is made up of interconnected nodes that share access to the same database or databases. Typically, the nodes are interconnected via a network and share access, in varying degrees, to shared storage, e.g. shared access to a set of disk drives and data blocks stored thereon. The varying degrees of shared access between the nodes may include shared nothing, shared everything, exclusive access to database partitions by node, or some combination thereof. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

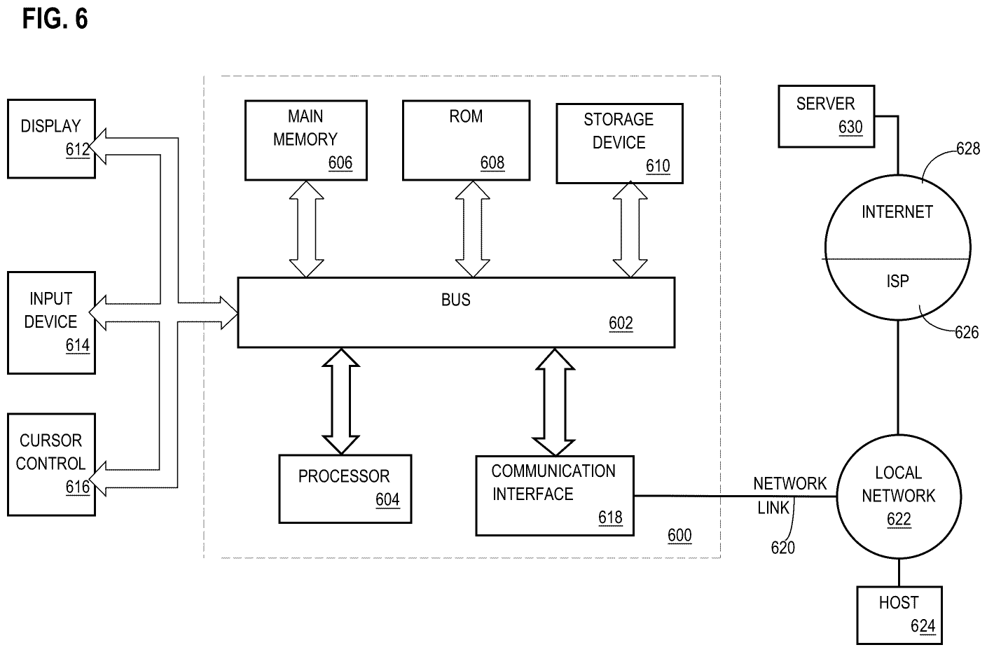

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### Software Overview

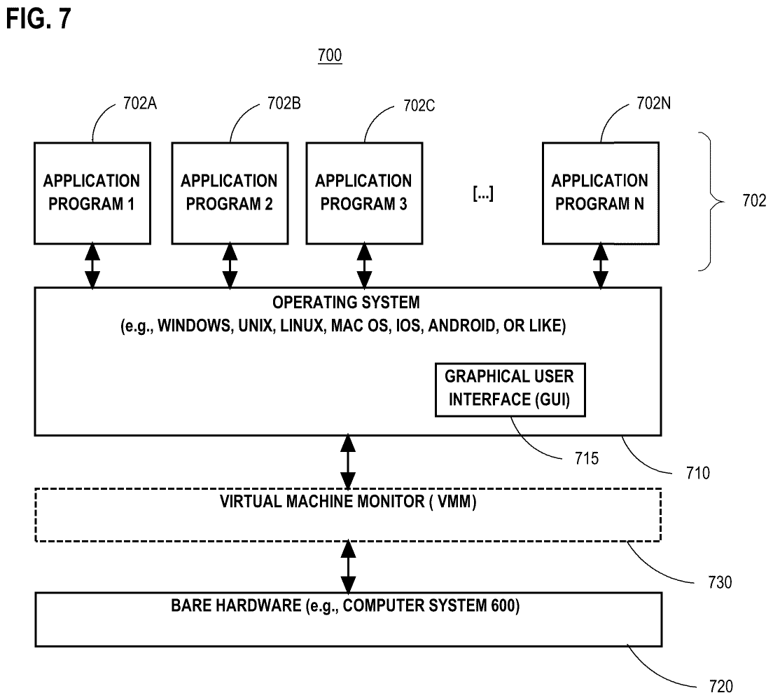

FIG. 7 is a block diagram of a basic software system 700 that may be employed for controlling the operation of computing system 600. Software system 700 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 700 is provided for directing the operation of computing system 600. Software system 700, which may be stored in system memory (RAM) 606 and on fixed storage (e.g., hard disk or flash memory) 610, includes a kernel or operating system (OS) 710.

The OS 710 manages low-level aspects of computer operation, including managing execution of processes, memory allocation, file input and output (I/O), and device I/O. One or more application programs, represented as 702A, 702B, 702C . . . 702N, may be “loaded” (e.g., transferred from fixed storage 610 into memory 606) for execution by the system 700. The applications or other software intended for use on computer system 600 may also be stored as a set of downloadable computer-executable instructions, for example, for downloading and installation from an Internet location (e.g., a Web server, an app store, or other online service).

Software system 700 includes a graphical user interface (GUI) 715, for receiving user commands and data in a graphical (e.g., “point-and-click” or “touch gesture”) fashion. These inputs, in turn, may be acted upon by the system 700 in accordance with instructions from operating system 710 and/or application(s) 702. The GUI 715 also serves to display the results of operation from the OS 710 and application(s) 702, whereupon the user may supply additional inputs or terminate the session (e.g., log off).

OS 710 can execute directly on the bare hardware 720 (e.g., processor(s) 604) of computer system 600. Alternatively, a hypervisor or virtual machine monitor (VMM) 730 may be interposed between the bare hardware 720 and the OS 710. In this configuration, VMM 730 acts as a software “cushion” or virtualization layer between the OS 710 and the bare hardware 720 of the computer system 600.

VMM 730 instantiates and runs one or more virtual machine instances (“guest machines”). Each guest machine comprises a “guest” operating system, such as OS 710, and one or more applications, such as application(s) 702, designed to execute on the guest operating system. The VMM 730 presents the guest operating systems with a virtual operating platform and manages the execution of the guest operating systems.

In some instances, the VMM 730 may allow a guest operating system to run as if it is running on the bare hardware 720 of computer system 700 directly. In these instances, the same version of the guest operating system configured to execute on the bare hardware 720 directly may also execute on VMM 730 without modification or reconfiguration. In other words, VMM 730 may provide full hardware and CPU virtualization to a guest operating system in some instances.

In other instances, a guest operating system may be specially designed or configured to execute on VMM 730 for efficiency. In these instances, the guest operating system is “aware” that it executes on a virtual machine monitor. In other words, VMM 730 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (Saas), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising in a database session, performing:
receiving a structured query language (SQL) statement that references a user-defined subroutine that is defined in an imperative language;
generating, in response to said receiving, a wrapper subroutine that is defined in the imperative language, wherein the wrapper subroutine specifies a datatype conversion for a parameter for the user-defined subroutine; and
executing the SQL statement, including executing the wrapper subroutine, including executing the user-defined subroutine.

2. The method of claim 1 wherein:
said SQL statement is a first SQL statement;
the method further comprises executing a distinct second SQL statement, including executing a particular wrapper, including executing the user-defined subroutine;
the particular wrapper is selected from a group consisting of: the wrapper subroutine and a wrapper that is not the wrapper subroutine.

3. The method of claim 2 wherein:
the first SQL statement specifies a distinct first value for the parameter;
the second SQL statement specifies a distinct second value for the parameter;
said executing the first SQL statement comprises performing a partial evaluation based on the distinct first value;
the partial evaluation is selected from a group consisting of a partial evaluation that is based on the second value and a partial evaluation that is not based on the second distinct value.

4. The method of claim 3 wherein the partial evaluation comprises at least one selected from a group consisting of: an inlining, a dead code elimination, a constant folding, and a partial evaluation based on polymorphism of the parameter.

5. The method of claim 2 wherein:
said user-defined subroutine and a second user-defined subroutine have a same signature;
the method further comprising:
a) in response to said receiving, generating a subroutine skeleton that represents said same signature,
b) from the subroutine skeleton, generating said wrapper subroutine and a second wrapper subroutine.

6. The method of claim 1 wherein:
said parameter is a first parameter;
said datatype conversion is a first datatype conversion that is specified in a first logic statement in the user-defined subroutine;
the wrapper subroutine specifies a second datatype conversion for a second parameter for the user-defined subroutine;
the second datatype conversion is specified in a second logic statement in the user-defined subroutine.

7. The method of claim 1 wherein the wrapper subroutine does not specify at least one selected from a group consisting of iteration and conditional logic.

8. The method of claim 1 wherein said executing the wrapper subroutine comprises after said generating, performing at least one action selected from a group consisting of:
a) an inlining of the user-defined subroutine into the wrapper subroutine and
b) to hardware instructions, a compilation of at least a portion of: the wrapper subroutine or the user-defined subroutine.

9. The method of claim 1 wherein the parameter is an output parameter or an input/output parameter.

10. The method of claim 1 wherein said generating is responsive to detecting that a count of parameters for the user-defined subroutine does not exceed a threshold that is greater than one.

11. The method of claim 1 wherein said executing the SQL statement comprises:
a) from a database table, processing a first table row and a second table row, and
b) executing the wrapper subroutine exactly once, including:
i) first executing the user-defined subroutine, wherein said parameter is based on the first table row, and
ii) second executing the user-defined subroutine, wherein said parameter is based on the second table row.

12. The method of claim 1 wherein said generating comprises:
from a signature for the user-defined subroutine, generating a subroutine skeleton that is defined in an interface description language that is a domain specific language (DSL);
generating an abstract syntax tree (AST) that represents the subroutine skeleton, wherein the AST contains a subtree that contains a leaf node;
in a copy of the AST, replacing the subtree with a plurality of tree nodes that represent the user-defined subroutine.

13. The method of claim 1 further comprising from a cache, evicting an AST that represents a subroutine skeleton.

14. One or more computer-readable non-transitory media storing instructions that, when executed by one or more computers, cause performing in a database session:
receiving a structured query language (SQL) statement that references a user-defined subroutine that is defined in an imperative language;
generating, in response to said receiving, a wrapper subroutine that is defined in the imperative language, wherein the wrapper subroutine specifies a datatype conversion for a parameter for the user-defined subroutine; and
executing the SQL statement, including executing the wrapper subroutine, including executing the user-defined subroutine.

15. The one or more computer-readable non-transitory media of claim 14 wherein:
said SQL statement is a first SQL statement;
the instructions further cause executing a distinct second SQL statement, including executing a particular wrapper, including executing the user-defined subroutine;
the particular wrapper is selected from a group consisting of: the wrapper subroutine and a wrapper that is not the wrapper subroutine.

16. The one or more computer-readable non-transitory media of claim 15 wherein:
the first SQL statement specifies a distinct first value for the parameter;
the second SQL statement specifies a distinct second value for the parameter;
said executing the first SQL statement comprises performing a partial evaluation based on the distinct first value;
the partial evaluation is selected from a group consisting of a partial evaluation that is based on the second value and a partial evaluation that is not based on the second distinct value.

17. The one or more computer-readable non-transitory media of claim 15 wherein:
said user-defined subroutine and a second user-defined subroutine have a same signature;
the instructions further cause:
a) in response to said receiving, generating a subroutine skeleton that represents said same signature,
b) from the subroutine skeleton, generating said wrapper subroutine and a second wrapper subroutine.

18. The one or more computer-readable non-transitory media of claim 14 wherein the wrapper subroutine does not specify at least one selected from a group consisting of iteration and conditional logic.

19. The one or more computer-readable non-transitory media of claim 14 wherein said executing the wrapper subroutine comprises after said generating, performing at least one action selected from a group consisting of:
a) an inlining of the user-defined subroutine into the wrapper subroutine and
b) to hardware instructions, a compilation of at least a portion of: the wrapper subroutine or the user-defined subroutine.

20. The one or more computer-readable non-transitory media of claim 14 wherein said executing the SQL statement comprises:
a) from a database table, processing a first table row and a second table row, and
b) executing the wrapper subroutine exactly once, including:
i) first executing the user-defined subroutine, wherein said parameter is based on the first table row, and
ii) second executing the user-defined subroutine, wherein said parameter is based on the second table row.
